(19) United States
(12) Patent Application Publication
(10) Pub. No.: US 2026/0259413 A1
(43) Pub. Date: Sep. 3, 2026

(54) WAVEGUIDE GRATING DEPTH AND FILLING FACTOR DUAL MODULATION

(71) Applicant: GOOGLE LLC, Mountain View, CA (US)

(72) Inventors: Lu Tian, Palo Alto, CA (US); Wei Jin, Saratoga, CA (US); Joseph Daniel Lowney, Tucson, AZ (US); Thomas Mercier, Weston, FL (US)

(21) Appl. No.: 18/878,478

(22) PCT Filed: May 4, 2023
(86) PCT No.: PCT/US2023/020924

§ 371 Date: Dec. 23, 2024

Related U.S. Application Data
(60) Provisional application No. 63/354,737, filed on Jun. 23, 2022.

(51) Int. Cl. G02B 27/01; G02B 6/34

(52) U.S. Cl. CPC G02B 27/0172; G02B 6/34

(57) ABSTRACT

Inverse aspect-ratio dependent etching (ARDE) effects are utilized to produce grating structures with modulation of etch depth and/or grating filling factor. A series of grating trenches (201-209) is defined for etching in an optical substrate of a waveguide (210), each grating trench having a depth and a width. The series of grating trenches is formed in the optical substrate by removing a portion of the optical substrate from each of the grating trenches, such that forming the series includes modulating a respective etch depth of each grating trench of the series of grating trenches along a first dimension (250).

### BACKGROUND

The present disclosure relates generally to augmented reality (AR) eyewear, which fuses a view of the real world with a heads-up display overlay. Wearable display devices, which include wearable heads-up displays (WHUDs) and head-mounted display (HMD) devices (all of which may be used interchangeably herein), are wearable electronic devices that combine real world and virtual images via one or more optical combiners, such as one or more integrated combiner lenses, to provide a virtual display that is viewable by a user when the wearable display device is worn on the head of the user. One class of optical combiner uses a waveguide (also termed a lightguide) to transfer light. In general, light from a projector of the wearable display device enters the waveguide of the optical combiner through an incoupler, propagates along the waveguide via total internal reflection (TIR), and exits the waveguide through an outcoupler. If the pupil of the eye is aligned with one or more exit pupils provided by the outcoupler, at least a portion of the light exiting through the outcoupler will enter the pupil of the eye, thereby enabling the user to see a virtual image. Since the combiner lens is transparent, the user will also be able to see the real world.

### BRIEF SUMMARY OF SELECTED EMBODIMENTS

Embodiments of techniques described herein utilize inverse aspect ratio dependent etching (ARDE) effects to produce grating structures with dual modulation—that is, modulation of both grating depth and grating filling factor. In various embodiments, a reactive ion etch (RIE) condition is optimized to produce depth variation by controlling an opening size of a hard mask used when etching the grating structures, such that smaller openings in the hard mask result in deeper trench depth and larger openings in the hard mask result in shallower trench depth.

In an embodiment, a method comprises defining a series of grating trenches for etching in an optical substrate of a waveguide, each grating trench having a depth and a width; and forming the series of grating trenches in the optical substrate by removing a portion of the optical substrate from each of the grating trenches, such that forming the series includes modulating a respective etch depth of each grating trench of the series of grating trenches along a first dimension.

Modulating the respective etch depth along the first dimension may include defining a first grating trench to have a first etch depth that is greater than a second etch depth of a second grating trench, the first grating trench being positioned further along the first dimension than the second grating trench.

The method may further include modulating along the first dimension a respective etching speed at which the portion of the optical substrate is removed from each grating trench of the series of grating trenches.

Modulating the etching speed for the series of grating trenches may include modulating the etching speed in accordance with a width of each grating trench. Modulating the etching speed in accordance with a width of each grating trench may include etching a first grating trench of the series more quickly than a second grating trench of the series, the first grating trench having a width that is less than that of the second grating trench.

The width of each grating trench of the series of grating trenches may be less than 20 μm.

Defining the series of grating trenches may include defining each of the grating trenches to have a substantially identical pitch.

Forming the series of grating trenches may include removing the portion of the optical substrate from each of the grating trenches using a pulsed energy source.

The series of grating trenches may comprise at least a portion of an optical element of the waveguide, the optical element being one of a group that includes an incoupler of the waveguide or an outcoupler of the waveguide.

In an embodiment, an optical waveguide comprises an optical substrate, and a diffractive grating formed in the optical substrate by removal of the optical substrate from a series of grating trenches, each grating trench of the series of grating trenches having an etch depth and a width, such that the etch depth for the series of grating trenches is modulated along a first dimension.

The respective etch depth may be modulated along the first dimension such that a first grating trench of the series has a first etch depth that is greater than a second etch depth of a second grating trench of the series, the first grating trench being positioned further along the first dimension than the second grating trench.

The width of each grating trench of the series of grating trenches may be less than 20 μm.

Each grating trench of the series of grating trenches may have a substantially identical pitch.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a diagram of a wearable near-eye display device in accordance with some embodiments.

FIG. 2 illustrates a cross-sectional view of a grating structure etched in the surface of a refractive waveguide in accordance with some embodiments.

FIG. 3 illustrates aspect ratio dependent etching lag as a function of trench width.

FIG. 4 shows trenches with varying widths, along with the corresponding associated aspect ratio dependent etching lag.

FIG. 5 illustrates stages of an etching process used in the creation of grating structures in an optical substrate that forms the surface of a waveguide, in accordance with some embodiments.

FIG. 6 illustrates use of a pulsed plasma source to facilitate greater control over etched trench depth in an optical substrate, in accordance with some embodiments.

### DETAILED DESCRIPTION

Wearable display devices for presenting AR content typically employ an optical combiner light guide (also referred to herein as a “refractive waveguide,” “optical waveguide,” or simply “waveguide”) to convey display light emitted by a display to a user's eye while also permitting light from the real-world scene to pass through the waveguide to the user's eye, resulting in the imagery represented by the display light overlaying the real-world scene from the perspective of the user. Typically, the optical waveguide relies on total internal reflection (TIR) to convey light received from the display via incoupling features at one end of the waveguide to outcoupling features facing the user's eye on the other end of the waveguide. The outcoupling features are configured to direct light beams from within the waveguide out of the waveguide such that the user perceives the projected light beams as images displayed in a field of view (FOV) area of a display component located in front of a user's eye, such as a lens of an HMD device having the general shape and size of eyeglasses. The light beams exiting from the waveguide then overlap at an eye relief distance from the waveguide, forming a “pupil” within which a virtual image generated by the image source can be viewed.

A relatively large FOV area and pupil are desirable in an HMD device to provide an in-focus, immersive experience to the user. It is also desirable that an HMD device be able to fit a variety of users despite differences in a relative size and position of those users' respective facial features in relation to components of the HMD. For example, one design consideration for an HMD device that can be worn by a wide range of users is the “eyebox”, or a 3D volume in space within which the pupil of an eye must be positioned in order to satisfy a series of viewing experience criteria (such as the user being able to see all four edges of a virtual image). The larger the eyebox, the larger the range of users the HMD device can accommodate. Increasing the size of the eyebox of an HMD generally corresponds to an expansion of the FOV area and pupil of the HMD as well.

A number of design elements of an HMD device contribute to the size of the FOV area, pupil, and eyebox. For example, the outcoupling features within the outcoupling region of a waveguide can be configured to provide an expanded FOV while also expanding the pupil and eyebox.

Holographic volume diffractive gratings (which may be referred to herein simply as gratings for expediency) comprise parallel trenches at various depths that are formed via surface etching during the creation of incoupler and outcoupler areas of a relevant waveguide due to resulting diffractive properties. Generally, an incoupling grating is used to couple the light from the projector into the waveguide system and an outcoupling grating is used to couple propagating light out of the waveguide and send the images to the human eyes.

Depth and filling factor are characteristics of waveguide gratings that correlate to AR waveguide diffraction efficiency. In order to improve optical uniformity within a diffractive optical element area (e.g., a diffractive incoupler or diffractive outcoupler), the grating structures for that area are designed and produced with either filling factor variation or grating depth modulation. It is often challenging to produce a grating area with both depth and filling factor modulations, as the grating trench depth is directly proportional to the filling factor and inversely proportional to a size of an air groove opening (the width of a trench opening at the surface of the waveguide).

Aspect ratio dependent etching (ARDE) lag, also called reactive ion etch (RIE) lag, refers to an etching phenomenon in which large opening features etch more quickly than smaller opening features. Embodiments of techniques described herein utilize inverse ARDE effects to produce grating structures with dual modulation—that is, modulation of both grating depth and grating filling factor. In various embodiments, a RIE condition is optimized to produce depth variation by controlling an opening size of a hard mask used when etching the grating structures, such that smaller openings in the hard mask result in deeper trench depth and larger openings in the hard mask result in shallower trench depth. This etching condition can be applied for producing nanoimprint lithography (NIL) master masks (e.g., quartz or silicon) and directly patterned for use in forming a high-index refractive waveguide. ARDE occurs differently with a microloading effect, which occurs when there are different densities of etching patterns having the same size. Generally, low density patterned areas etch faster than high density patterned areas. In certain embodiments, the etched grating trenches share a substantially similar pitch, such that the feature density within one incoupler/outcoupler area is substantially identical.

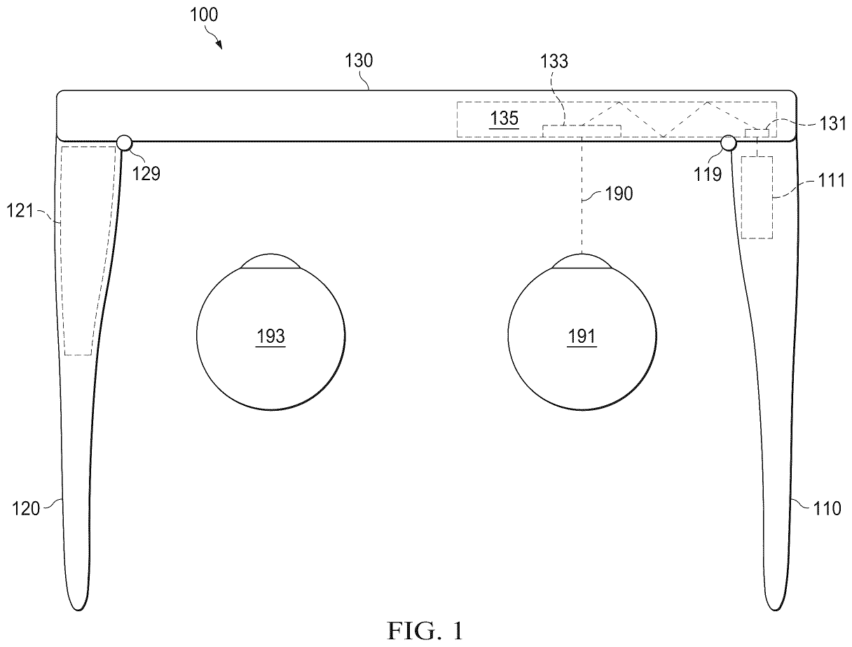

FIG. 1 illustrates a diagram of a wearable display device 100 in accordance with some embodiments. In some embodiments, the wearable display device 100 may implement or be implemented by aspects of the wearable display device 100. For example, the wearable display device 100 may include a first arm 110, a second arm 120, and a front frame 130. The first arm 110 may be coupled to the front frame 130 by a hinge 119, which allows the first arm 110 to rotate relative to the front frame 130. The second arm 120 may be coupled to the front frame 130 by the hinge 129, which allows the second arm 120 to rotate relative to the front frame 130.

In the example of FIG. 1, the wearable display device 100 may be in an unfolded configuration, in which the first arm 110 and the second arm 120 are rotated such that the wearable display device 100 can be worn on a head of a user, with the first arm 110 positioned on a first side of the head of the user, the second arm 120 positioned on a second side of the head of the user opposite the first side, and the front frame 130 positioned on a front of the head of the user. The first arm 110 and the second arm 120 can be rotated towards the front frame 130, until both the first arm 110 and the second arm 120 are approximately parallel to the front frame 130, such that the wearable display device 100 may be in a compact shape that fits conveniently in a rectangular, cylindrical, or oblong case. Alternatively, the first arm 110 and the second arm 120 may be fixedly mounted to the front frame 130, such that the wearable display device 100 cannot be folded.

In the depicted embodiment, the first arm 110 carries a light engine 111. The second arm 120 carries a power source 121. The front frame 130 carries a diffractive waveguide 135 including an incoupling optical redirector (incoupler) 131, an outcoupling optical redirector (outcoupler) 133, and at least one set of electrically conductive current paths, which provide electrical coupling between the power source 121 and electrical components (such as the light engine 111) carried by the first arm 110. Such electrical coupling could be provided indirectly, such as through a power supply circuit, or could be provided directly from the power source 121 to each electrical component in the first arm 110. As used herein, the terms carry, carries or similar do not necessarily dictate that one component physically supports another component. For example, it is stated above that the first arm 110 carries the light engine 111. This could mean that the light engine 111 is mounted to or within the first arm 110, such that the first arm 110 physically supports the light engine 111. However, it could also describe a direct or indirect coupling relationship, even when the first arm 110 is not necessarily physically supporting the light engine 111.

The light engine 111 can output a display light 190 (simplified for this example) representative of AR content or other display content to be viewed by a user. The display light 190 can be redirected by diffractive waveguide 135 towards an eye 191 of the user, such that the user can see the AR content. The display light 190 from the light engine 111 impinges on the incoupler 131 and is redirected to travel in a volume of the diffractive waveguide 135, where the display light 190 is guided through the light guide, such as by total internal reflection (TIR) and/or surface treatments such as holograms or reflective coatings. Subsequently, the display light 190 traveling in the volume of the diffractive waveguide 135 impinges on the outcoupler 133, which redirects the display light 190 out of the diffractive waveguide 135 and towards the eye 191 of a user. In the wearable display device 100, the depicted outcoupler 133 is an HOE outcoupler with an eye-facing surface 136 that is parallel to (and possibly coplanar with) an eye-facing surface 137 of the waveguide 135. In certain embodiments, additional optical components may be included, such as if the wearable display device 100 is to provide AR content to both of a user's eyes. For example, in certain embodiments an additional light engine and waveguide (not shown) are provided to generate and direct AR content to the user's other eye 193.

The wearable display device 100 may include a processor (not shown) that is communicatively coupled to each of the electrical components in the wearable display device 100, including but not limited to the light engine 111. The processor can be any suitable component which can execute instructions or logic, including but not limited to a micro-controller, microprocessor, multi-core processor, integrated-circuit, ASIC, FPGA, programmable logic device, or any appropriate combination of these components. The wearable display device 100 can include a non-transitory processor-readable storage medium, which may store processor readable instructions thereon, which when executed by the processor can cause the processor to execute any number of functions, including causing the light engine 111 to output the light 190 representative of display content to be viewed by a user, receiving user input, managing user interfaces, generating display content to be presented to a user, receiving and managing data from any sensors carried by the wearable display device 100, receiving and processing external data and messages, and any other functions as appropriate for a given application. The non-transitory processor-readable storage medium can be any suitable component, which can store instructions, logic, or programs, including but not limited to non-volatile or volatile memory, read only memory (ROM), random access memory (RAM), FLASH memory, registers, magnetic hard disk, optical disk, or any combination of these components.

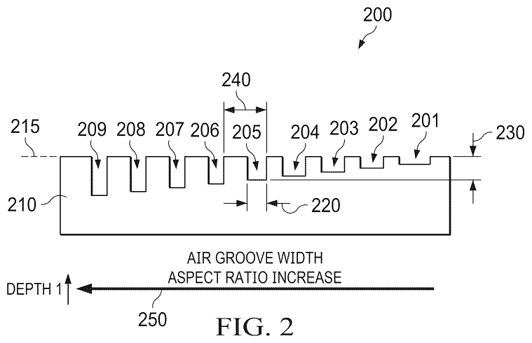

FIG. 2 illustrates a cross-sectional view of a grating structure 200 etched in an optical substrate 210 of a refractive waveguide (not separately shown), such as for use as an incoupler or outcoupler of the waveguide. Each etched trench 201, 202, 203, 204, 205, 206, 207, 208, 209 (collectively identified herein as etched trenches 201-209) of the grating structure 200 is defined by a neighboring unetched column, with the top of the columns (and of etched trenches 201-209) occurring at a surface level 215 of the grating structure 200.

As depicted, the air groove width 220 is seen as the width of the top trench opening, with the pitch 240 corresponding to the horizontal linear distance between similar edges of neighboring etched trenches. It will be appreciated that although the air groove width 220, pitch 240, and depth 230 are illustrated for etched trench 205, similarly oriented characteristics apply to all of etched trenches 201-209. The etched trenches 201-209 are modulated in both depth and width from the rightmost to the leftmost-in particular, when considering the etched trenches 201-209 along the direction 250, the respective depths of the etched trenches 201-209 increase, while the widths (air groove width 220) decrease, such that the pitch 240 remains substantially identical. In this manner, the aspect ratio (the ratio of depth to width of the respective etched trench) increases for the etched trenches 201-209 along the direction 250.

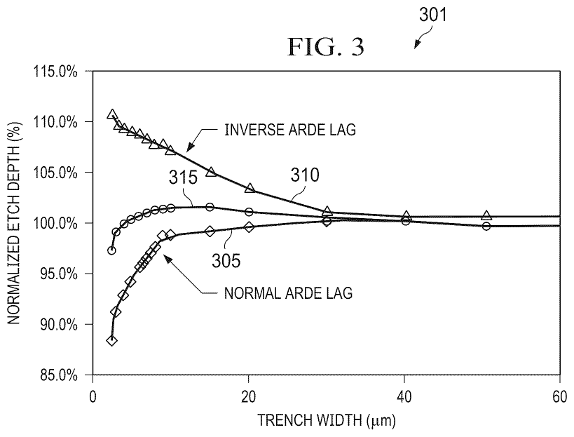

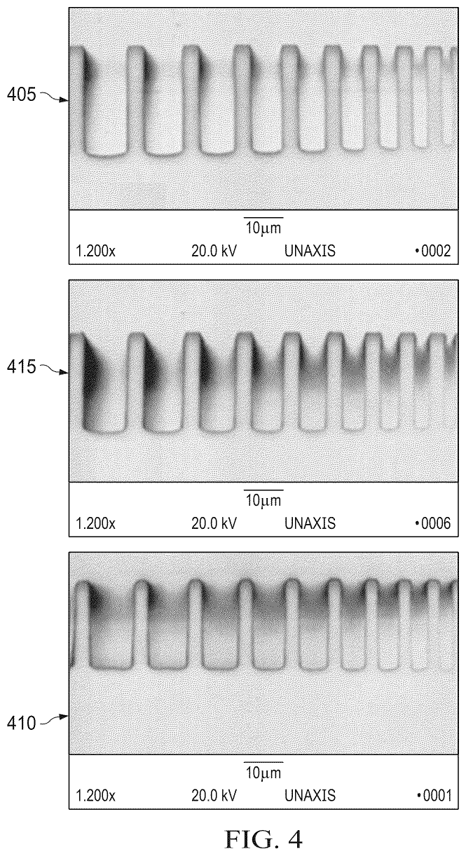

FIGS. 3 and 4 illustrate ARDE lag. Etching for sub-micron trench features, such as in instances of grating elements measured in hundreds of nanometers, are highly sensitive to etching conditions, indicating that an inverse ARDE effect may be achieved. In an inverse ARDE process, the etch condition is modified toward faster etching for small feature openings and slower etching for large openings.

FIG. 3 illustrates a data graph 301 representing ARDE lag as a function of trench width. In particular, the data graph 301 illustrates three separate data series 305, 310, 315 respectively indicating a ratio curve for normal ARDE lag, inverse ARDE lag, and ARDE lag-free relationships between an etched trench width (as measured in μm) and a percentage of a normalized etch depth.

In the data graph 301, a first data series 305 depicts normal ARDE lag, in which the etch rate increases as the trench width increases, resulting in a greater etched depth for wider trenches. A second data series 310 depicts the opposite phenomenon of inverse ARDE lag, in which the etch rate increases as the trench width decreases, resulting in a greater etched depth for narrower trenches. The third data series 315 depicts a substantially ARDE lag-free etching situation, exhibiting a linear etch rate as a function of trench width, such as is commonly observed in isotropic etching processes (wet chemical etching or some plasma-based processes) in which the etch rate is primarily controlled by the concentration of reactive species in the etching environment.

Embodiments of waveguides etched in accordance with techniques described herein are often etched with grating trenches measured in the hundreds of nanometers, and therefore occurring towards the leftmost region of the data graph 301.

FIG. 4 depicts images of trenches with etch widths ranging from 2.5 μm to 10 μm, along with the corresponding ARDE lag associated with those etch widths. In particular, image 405 indicates a normal ARDE lag condition of approximately 10%; image 415 shows ARDE lag being effectively eliminated at approximately 2%; and image 410 shows an inverse ARDE lag condition of approximately 5%.

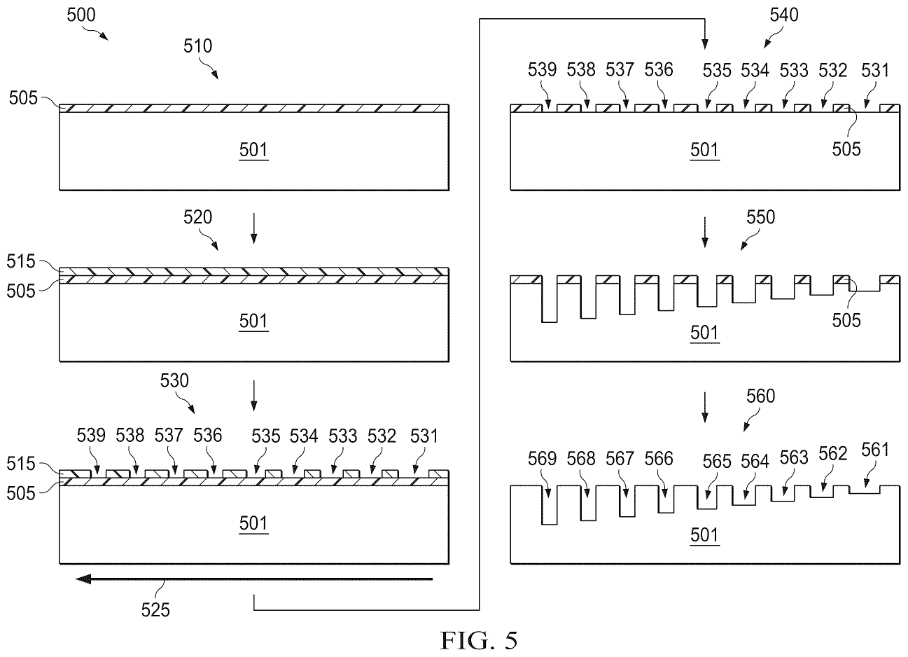

FIG. 5 illustrates various stages of an etching process 500 used in the creation of grating structures in an optical substrate 501, which forms the surface of a waveguide in accordance with some embodiments. The etching process is designed to transfer a pattern defined in a photoresist layer onto an underlying hard mask layer, form a depth-modulating pattern using an inverse ARDE lag effect, and remove the hard mask layer to leave the desired grating structure with a modulated etch depth.

In stage 510, the optical substrate 501 is coated with a hard-mask layer 505. The hard-mask layer 505 typically comprises one or more materials (e.g., silicon dioxide (SiO2), silicon nitride (Si3N4), titanium dioxide (TiO2), etc.) that are resistant to the etching chemistry used in the subsequent steps of the process. In certain embodiments, the hard-mask layer 505 is deposited onto the optical substrate 501 using a deposition technique such as sputtering or chemical vapor deposition (CVD). The etching process 500 continues to stage 520.

In stage 520, a photoresist layer 515 is deposited onto the hard-mask layer. The etching process 500 continues to stage 530.

At stage 530, the photoresist layer 515 is exposed to an energy source (e.g., a light source, not separately depicted) via a patterned mask (not shown) that contains a desired grating pattern, such that the grating pattern is transferred to the photoresist layer by controlling the exposure. The unexposed portions of the photoresist layer 515 are then removed (e.g., via chemical solution), leaving a pattern of openings 531, 532, 533, 534, 535, 536, 537, 538, 539 (collectively identified herein as openings 531-539) as depicted in the photoresist layer 515 at stage 530.

In a manner similar to that described with respect to the etched trenches 201-209 of the grating structure 200 in FIG. 2, the respective widths of each of openings 531-539 are modulated such that the respective widths increase based on the position of the respective opening along direction 525. However, in various embodiments, and also as described above with respect to the etched trenches 201-209, the pitch remains substantially identical for all of openings 531-539. The etching process 500 continues to stage 540.

At stage 540, the patterned photoresist layer 515 is used as a mask to transfer the grating pattern to the underlying hard-mask layer 505, such as via a plasma etch process. In this manner, the hard-mask layer 505 is removed from areas not overlaid by the photoresist layer 515. The photoresist layer is then removed, such as via a known solvent or plasma ashing process, leaving the desired patterned hard-mask layer 505. The etching process 500 continues to stage 550.

At stage 550, an inverse ARDE effect is utilized to form a depth modulation pattern using openings 531-539 as now defined in the hard mask layer 505. As can be seen in the stage 550, in this inverse ARDE effect, the etch rate increases as the trench width decreases, resulting in a deeper etched depth for narrower trenches. The etching process 500 continues to stage 560.

In certain embodiments, trench shadowing (in which etching is impeded in regions that are shielded from the etching plasma by overhanging features, such as narrow trenches or high aspect-ratio features) may be utilized to differentiate the passivation and passivation removal speed, thereby controlling the downward etch rate (the rate at which material from an intended trench is vertically removed). In certain embodiments, the etchant-to-deposition gas flow ratio (e.g., a ratio of carbon versus fluoride) is modified to utilize a greater polymerizing condition in order to emphasize the trench shadowing effect. In various embodiments, other parameters may be modified to emphasize or mitigate such effects, including (as non-limiting examples) an angle of incidence of the etching plasma, a thickness and/or shape of the hard-mask layer 505, and the aspect ratio of the etched features.

In stage 560, the hard-mask layer 505 is removed from the underlying optical substrate 501, such as via a known selective etch process, leaving the depth-modulated and width-modulated series of etched trenches 561, 562, 563, 564, 565, 566, 567, 568, 569 (collectively identified herein as etched trenches 561-569).

In certain embodiments, the target trench depth for an etched grating structure is in a range of tens of nanometers. Therefore, slowing the vertical etching speed allows better control of trench depth modulation. In certain embodiments, a pulsed plasma source may be utilized to form quasi-atomic-layer etching, facilitating greater depth control, such as in order to create shallow features. In addition, process factors may be tuned by adjusting one or more control factors that include, as non-limiting examples, one or more of: chamber pressure, RF power, gas flow, gas flow ratio, or wafer chuck temperature.

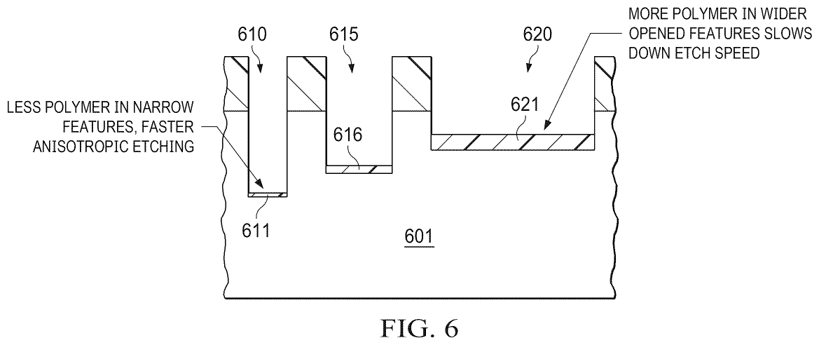

FIG. 6 illustrates use of a pulsed energy source (e.g., a pulsed plasma energy source) to facilitate greater control over etched trench depth in an optical substrate 601, in accordance with some embodiments. As seen in the depicted embodiment, narrower features such as those of etched trench 610 result in less polymer filling material 611, and correspondingly faster anisotropic etching. In contrast, wider features such as those of etched trench 620 correspond to greater deposition of polymer filling material 621, which slows down the speed of anisotropic etching. Accordingly, the middle etched trench 615—with a width between that of etched trenches 610 and 620—comprises a deposition of polymer filling material 616 greater than that in etched trench 610 but less than that in etched trench 620.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
defining a series of grating trenches for etching in an optical substrate of a waveguide, each grating trench having a depth and a width; and
forming the series of grating trenches in the optical substrate by removing a portion of the optical substrate from each of the grating trenches, wherein forming the series comprises modulating a respective etch depth of each grating trench of the series of grating trenches along a first dimension.

2. The method of claim 1, wherein modulating the respective etch depth along the first dimension comprises defining a first grating trench to have a first etch depth that is greater than a second etch depth of a second grating trench, the first grating trench being positioned further along the first dimension than the second grating trench.

3. The method of claim 1, further comprising modulating along the first dimension a respective etching speed at which the portion of the optical substrate is removed from each grating trench of the series of grating trenches.

4. The method of claim 1, wherein modulating the etching speed for the series of grating trenches comprises modulating the etching speed in accordance with a width of each grating trench.

5. The method of claim 4, wherein modulating the etching speed in accordance with a width of each grating trench comprises etching a first grating trench of the series more quickly than a second grating trench of the series, the first grating trench having a width that is less than that of the second grating trench.

6. The method of claim 1, wherein the width of each grating trench of the series of grating trenches is less than 20 μm.

7. The method of claim 1, wherein defining the series of grating trenches includes defining each of the grating trenches to have a substantially identical pitch.

8. The method of claim 1, wherein forming the series of grating trenches includes removing the portion of the optical substrate from each of the grating trenches using a pulsed energy source.

9. The method of claim 1, wherein the series of grating trenches comprises at least a portion of an optical element of the waveguide, the optical element being one of a group that includes an incoupler of the waveguide and an outcoupler of the waveguide.

10. (canceled)

11. (canceled)

12. An optical waveguide comprising:
an optical substrate; and
a diffractive grating formed in the optical substrate by removal of the optical substrate from a series of grating trenches, each grating trench of the series of grating trenches having an etch depth and a width;
wherein the etch depth for the series of grating trenches is modulated along a first dimension.

13. The optical waveguide of claim 12, wherein the respective etch depth is modulated along the first dimension such that a first grating trench of the series has a first etch depth that is greater than a second etch depth of a second grating trench of the series, the first grating trench being positioned further along the first dimension than the second grating trench.

14. The optical waveguide of claim 12, wherein the width of each grating trench of the series of grating trenches is less than 20 μm.

15. The optical waveguide of claim 12, wherein each grating trench of the series of grating trenches has a substantially identical pitch.

16. (canceled)

17. The optical waveguide of claim 12, wherein the series of grating trenches comprises at least a portion of an optical element of the waveguide, the optical element being one of a group that includes an incoupler of the waveguide and an outcoupler of the waveguide.

18. A wearable display device, comprising:
a light engine configured to output display light; and
a waveguide configured to receive the display light and direct the display light toward an eye of a user of the wearable display device, wherein the waveguide comprises:
an optical substrate; and
a diffractive grating formed in the optical substrate by removal of the optical substrate from a series of grating trenches, each grating trench of the series of grating trenches having an etch depth and a width;
wherein the etch depth for the series of grating trenches is modulated along a first dimension.

19. The wearable display device of claim 18, wherein the respective etch depth is modulated along the first dimension such that a first grating trench of the series has a first etch depth that is greater than a second etch depth of a second grating trench of the series, the first grating trench being positioned further along the first dimension than the second grating trench.

20. The wearable display device of claim 18, wherein the width of each grating trench of the series of grating trenches is less than 20 μm.

21. The wearable display device of claim 18, wherein each grating trench of the series of grating trenches has a substantially identical pitch.

22. The wearable display device of claim 18, wherein the series of grating trenches comprises at least a portion of an optical element of the waveguide, the optical element being one of a group that includes an incoupler of the waveguide and an outcoupler of the waveguide.
